(19) United States
(12) Patent Application Publication
(10) Pub. No.: US 2012/0183375 A1
(43) Pub. Date: Jul. 19, 2012

(54) SYSTEMS, METHODS, AND COMPONENTS FOR TRANSFERRING RADIOACTIVE MATERIAL

(75) Inventors: William Bracey, West Orange, NJ (US); Jayant R. Bondre, Clarksville, MD (US); Aleksandr Kofman, Rockville, MD (US); Robert L. Grubb, Ellicott City, MD (US)

(73) Assignee: TRANSNUCLEAR, INC., Columbia, MD (US)

(21) Appl. No.: 13/300,433

(22) Filed: Nov. 18, 2011

Related U.S. Application Data
(60) Provisional application No. 61/415,731, filed on Nov. 19, 2010.

(51) Int. Cl. G21C 19/00

(52) U.S. Cl. 414/146; 414/800

(57) ABSTRACT

A method of transferring radioactive material from a contaminated area to a container assembly generally includes acquiring radioactive material in a contaminated area, wherein the contaminated area includes at least one shielding wall, and moving the material in the substantially horizontal orientation through an aperture in a shielding wall into a container assembly. Other systems, methods, and components for transferring radioactive material are provided.

### CROSS-REFERENCE TO RELATED APPLICATION

This application claims the benefit of Provisional Application No. 61/415,731, filed Nov. 19, 2010, the disclosure of which is expressly incorporated herein by reference.

### BACKGROUND

There exists a need for systems and methods for transferring radioactive material from contaminated areas, for example, through a shielding wall, to a storage cask or container.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a method of transferring radioactive material from a contaminated area to a container assembly is provided. The method generally includes acquiring radioactive material in a contaminated area, wherein the contaminated area includes at least one shielding wall, and moving the material in the substantially horizontal orientation through an aperture in a shielding wall into a container assembly.

In accordance with another embodiment of the present disclosure, a transfer assembly for radioactive material is provided. The transfer assembly generally includes a material receiving assembly having an outer wall defining an inner bore and first and second open ends, wherein the material receiving assembly receives radioactive material when it is in a first orientation, and wherein the material receiving assembly rotates to a second orientation. The transfer assembly further includes a material delivery assembly configured for translational movement between the first and second ends of the material receiving assembly.

In accordance with another embodiment of the present disclosure, a shielding device for radioactive material positioned in a shielding wall between a contaminated area and a container assembly is provided. The shielding device generally includes a body having an aperture, wherein the body is rotatable such that the aperture corresponds with one of a plurality of compartments in the container assembly.

In accordance with another embodiment of the present disclosure, a system for rotating a cask is provided. The system generally includes a cask, a skid configurable between a first orientation for rotating the cask and a second orientation for maintaining the cask in a fixed position, and a removable track for rotating the cask when the skid is in the first orientation.

In accordance with another embodiment of the present disclosure, a skid for a cask is provided. The skid generally includes a base, a plurality of trunnion supports coupled to the base, wherein the trunnion supports are configurable between a first orientation for rotating the cask and a second orientation for maintaining the cask in a fixed position, wherein the trunnion supports support the cask when it is in the second orientation, and a plurality of rollers coupled to the base, wherein the plurality of rollers support the cask when it is in the first orientation.

In accordance with another embodiment of the present disclosure, a system for rotating a canister is provided. The system generally includes a canister, a cask surrounding the canister, wherein the cask is maintained in a fixed position, and wherein the cask and the canister are enabled for rotational movement of the canister relative to the cask.

In accordance with another embodiment of the present disclosure, a system for transferring radioactive material from a contaminated area to a container assembly is provided. The system generally includes at least one shielding wall having an aperture therethrough, a transfer assembly for delivering material through the aperture, and a container assembly for receiving the material.

### DESCRIPTION OF THE DRAWINGS

The foregoing aspects and many of the attendant advantages of this disclosure will become more readily appreciated by reference to the following detailed description, when taken in conjunction with the accompanying drawings, wherein:

FIG. 1 is a isometric view of a system for transferring radioactive material from a contaminated area through a shielding wall to a container assembly using a transfer assembly, in accordance with one embodiment of the present disclosure;

FIGS. 2-4 are side views of the transfer assembly of FIG. 1 in various different positions;

FIG. 5 is a side view with a partial cut away of the system of FIG. 1;

FIG. 6 is a side view of a shielding device positioned in the shielding wall for maintaining shielding between the contaminated and non-contaminated areas, which may be capable of rotational movement, in accordance with another embodiment of the present disclosure;

FIGS. 7A and 7B are front and back isometric views of the container assembly of FIG. 1 in a configuration enabled for rotation;

FIG. 8 is an exploded view of the container assembly of FIGS. 7A and 7B;

FIG. 9 is a front isometric view of the container assembly of FIGS. 7A and 7B in a configuration enabled for non-rotation, for example, for transportation;

FIG. 10 is a front side isometric view of the container assembly including an outer cask and an inner canister, in accordance with another embodiment of the present disclosure;

FIG. 11 is an exploded view of the container assembly of FIG. 10;

FIG. 12 is a back side isometric view of the inner canister of FIG. 10; and

FIGS. 13 and 14 are side end views of the container assembly of FIG. 10, with FIG. 14 illustrating the rotational movement of the canister relative to a stationary outer cask.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail so as not to unnecessarily obscure various aspects of the present disclosure. Further, it will be appreciated that embodiments of the present disclosure may employ any combination of features described herein.

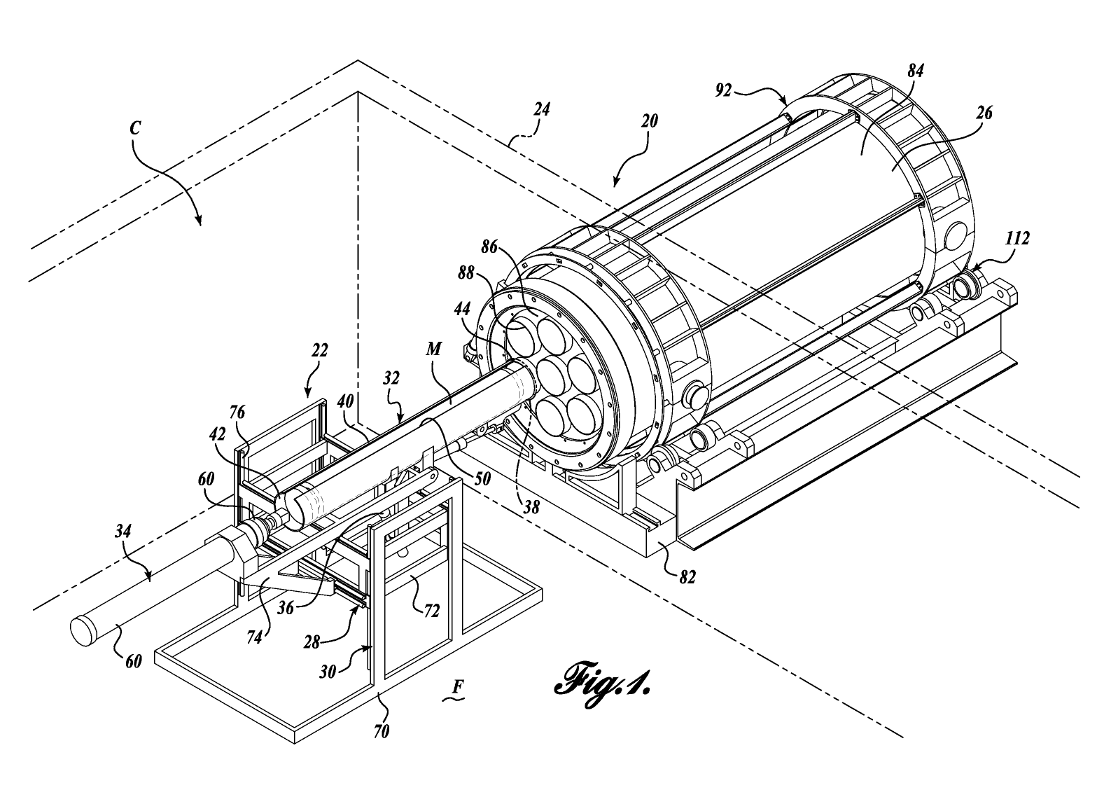

Embodiments of the present disclosure are generally directed to systems, methods, and components for transferring radioactive material, for example, from a contaminated area through a shielding wall to a container assembly using a transfer assembly. Referring to FIG. 1, a system 20 in accordance with one embodiment of the present disclosure is provided. The system 20 generally includes a transfer assembly 22 for transferring a radioactive material M from a contaminated area C through a shielding wall 24 to a container assembly 26.

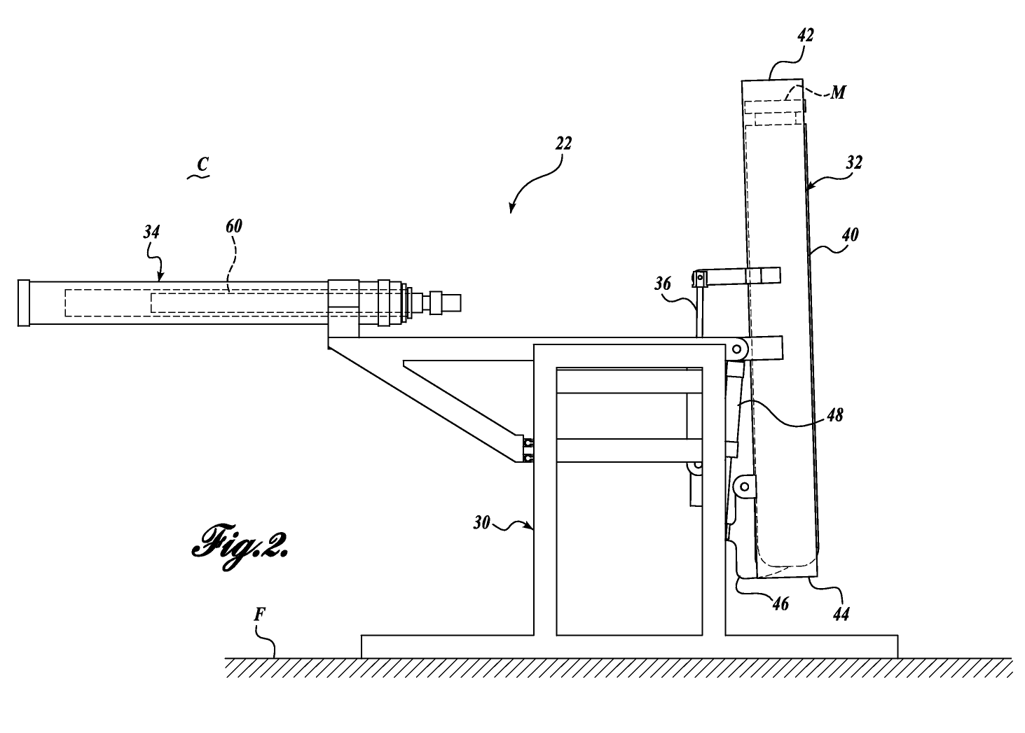

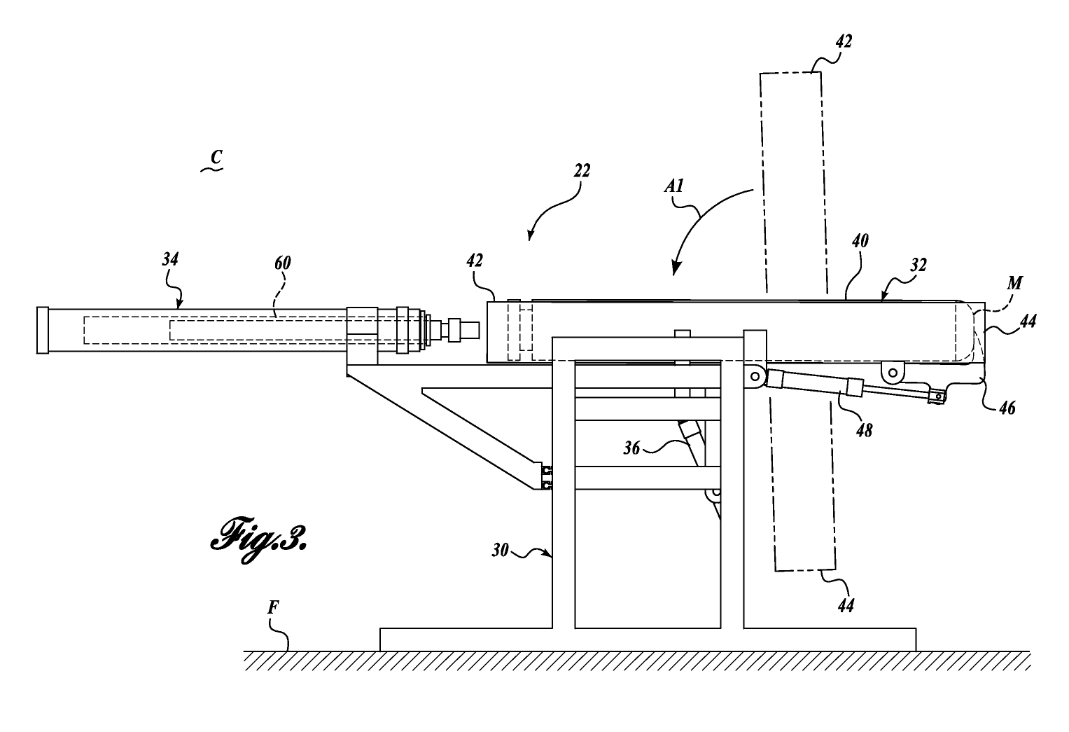

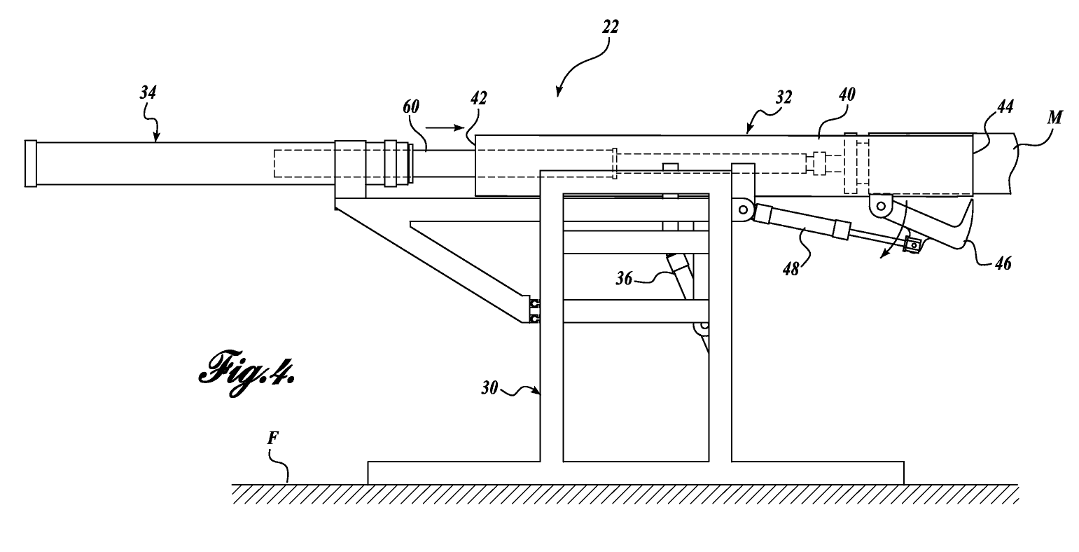

The transfer assembly 22 includes a frame assembly 30, a material receiving assembly 32, and a material delivery assembly 34. The transfer assembly 22 further may include an actuator assembly 36 for moving the material receiving assembly 32 between vertical and horizontal orientations (see also FIGS. 2-4). Another actuator assembly (not shown) also may be included in the transfer assembly for moving the material delivery assembly 34 between retracted and extended positions (compare the positioning of the material delivery assembly 34 in FIGS. 3 and 4). The transfer assembly 22 may further include an indexing assembly 28 for indexing the delivery of the material M with either of an aperture 38 in the shielding wall 24 or the container assembly 26, or both.

In the illustrated embodiment of FIG. 1, the transfer assembly 22 is shown in a horizontal retracted position. However, as seen in FIGS. 2-4, the transfer assembly 22 is configured to be positionable in various different positions. For example, referring to FIG. 2, the material receiving assembly 32 is shown in its substantially vertical orientation for receiving material M that is delivered to the material receiving assembly 32 in a substantially vertical orientation.

Referring to the view in FIG. 1, the material receiving assembly 32 has a tubular body 40 defining an inner bore, and first and second open ends 42 and 44. In the vertical orientation (see FIG. 2), the first open end 42 of the material receiving assembly 32 is the high end, and the second open end 44 is the low end. In one configuration of the illustrated embodiment, the first open end 42 may be the inlet for material M into the material receiving assembly 32. In that regard, the material M is inserted at the first open end 42 and slides into the tubular body 40. A material retaining device 46, for example, a releasable stop, may be engaged to prevent the material M from sliding out from the second open end 44. Referring to FIG. 4, the stop 46 may be released by an actuator assembly 48.

From the vertical orientation (see FIG. 2), the material receiving assembly 32 can be moved to a substantially horizontal orientation (see FIG. 3). As can be seen in FIG. 3, the material receiving assembly 32 pivots to the left in this view, in the direction of arrow A1) around a pivot point at about a midpoint along the length of the tubular body 40. In the horizontal orientation (see FIG. 3), the first open end 42 is nearest the material delivery assembly 34, and the second open end 44 is furthest from the material delivery assembly 34. Although shown and described as being received in the vertical orientation and delivered in the horizontal orientation, it should be appreciated that material M may also be received by the material receiving assembly 32 when it is in its horizontal orientation (see, e.g., FIG. 3).

Returning to FIG. 1, the material receiving assembly 32 further may include an opening or slit 50 along the length of the tubular body 40. In one embodiment of the present disclosure, the slit 50 may be the inlet for the material receiving assembly 32, for example, the slit 50 may be a half-trough cross-section defining an open side. Therefore, the material M may be inserted longitudinally through the slit 50 into the tubular body 40. After insertion, there may be one or more locks or clamping devices (not shown) to maintain the material M in the tubular body 40 and prevent it from falling out of the slit 50. In addition, as mentioned above, a releasable stop 46 may be engaged to prevent the material M from sliding out from the second open end 44 (see stop 46 released in FIG. 4).

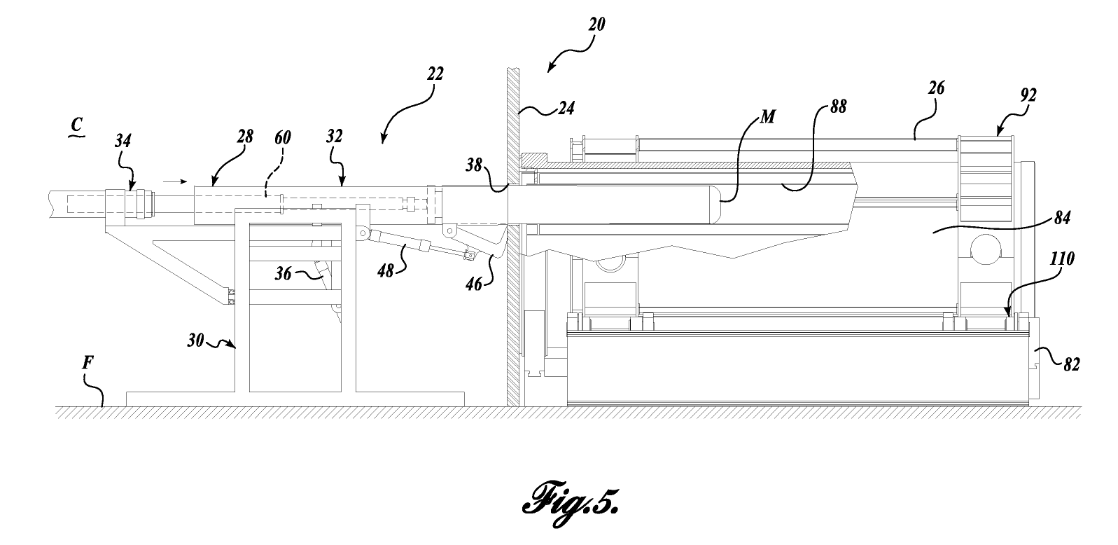

The material delivery assembly 34 delivers the material from the material receiving assembly 32, for example, through an aperture 38 in the shielding wall 24 or into the container assembly 26, or both. In the illustrated embodiment, the material delivery assembly includes a ramming device 60, for example, a telescoping ramming device. As can be seen by comparing FIGS. 2 and 4, the telescoping ramming device 60 is positionable between a retracted position (see FIG. 2) and an extended position (see FIG. 4). When the material receiving assembly 32 is in its substantially horizontal orientation, the telescoping ramming device 60 extends and pushes the material M out of the material receiving assembly 32 (see FIG. 4), and for example, may push it though the shielding wall 24 and/or into a container assembly 26 (see, for example, FIG. 5). Therefore, the ramming device 60 is configured for translational movement between the first and second ends 42 and 44 of the material receiving assembly 32.

Referring to FIG. 1, the frame assembly 30 supports all of the components in the transfer assembly 22, such as the material receiving assembly 32 and the material delivery assembly 34. In that regard, the frame assembly 30 ensures that the components are maintained at a proper height relative to one another and to facilitate delivery of the material M through an aperture 38 in the shielding wall 24 or into the container assembly 26, or both. To simplify the transfer of material from the transfer assembly 22, the frame assembly 30 may further include an indexing assembly 28 for moving the horizontal and/or vertical delivery coordinates of the transfer assembly 22 to align with either of an aperture 38 in the shielding wall 24, the container assembly 26, or both.

Still referring to FIG. 1, the indexing assembly 28 of the transfer assembly 22 includes both horizontal and vertical adjustment components. In that regard, the frame assembly 30 includes a stationary frame member 70, which may be coupled to or otherwise rests on the floor F. Coupled to the stationary frame member 70 is a moveable vertical frame member 72. Coupled to the moveable vertical frame member 72 is a moveable horizontal frame member 74. The moveable horizontal frame member 74 supports both the material receiving assembly 32 and the material delivery assembly 34. It should be appreciated, however, that either of the vertical frame member 72 or the horizontal frame member 74 may be coupled to the stationary frame member 70, with the other coupled to that member.

In the illustrated embodiment, the vertical frame member 72 is attached to the stationary frame member 70 by a first rail system 76, wherein the vertical frame member 72 glides on rails on the stationary frame member 70. In addition, the horizontal frame member 74 is attached to the vertical frame member 72 by a second rail system 78, wherein the horizontal frame member 74 glides on rails on the vertical frame member 72. As a result of the frame assembly 30, vertical and horizontal adjustments can be made to index the transfer assembly 22 with other components in the system 20 and enable directed delivery of the material M.

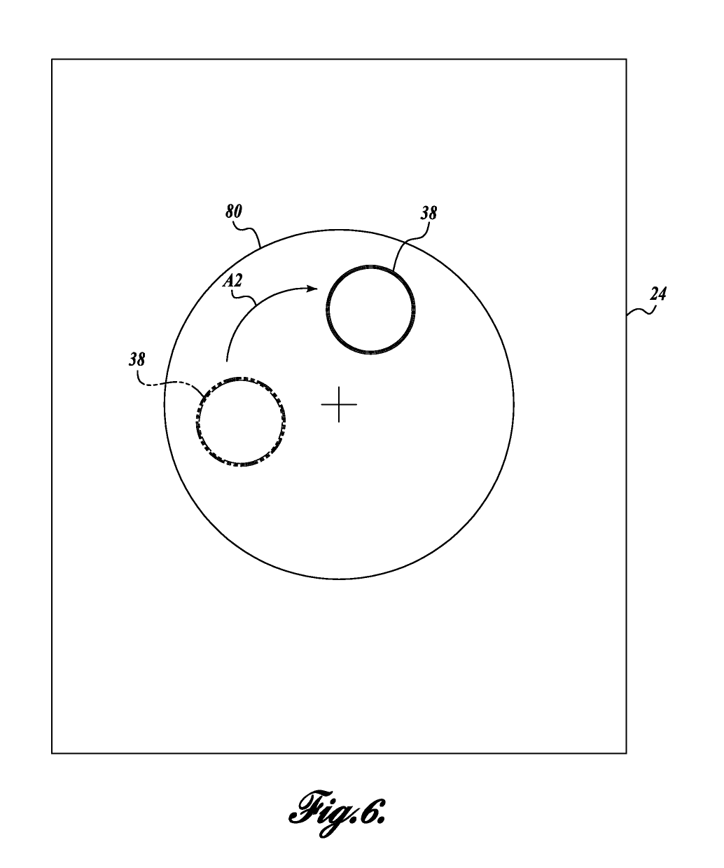

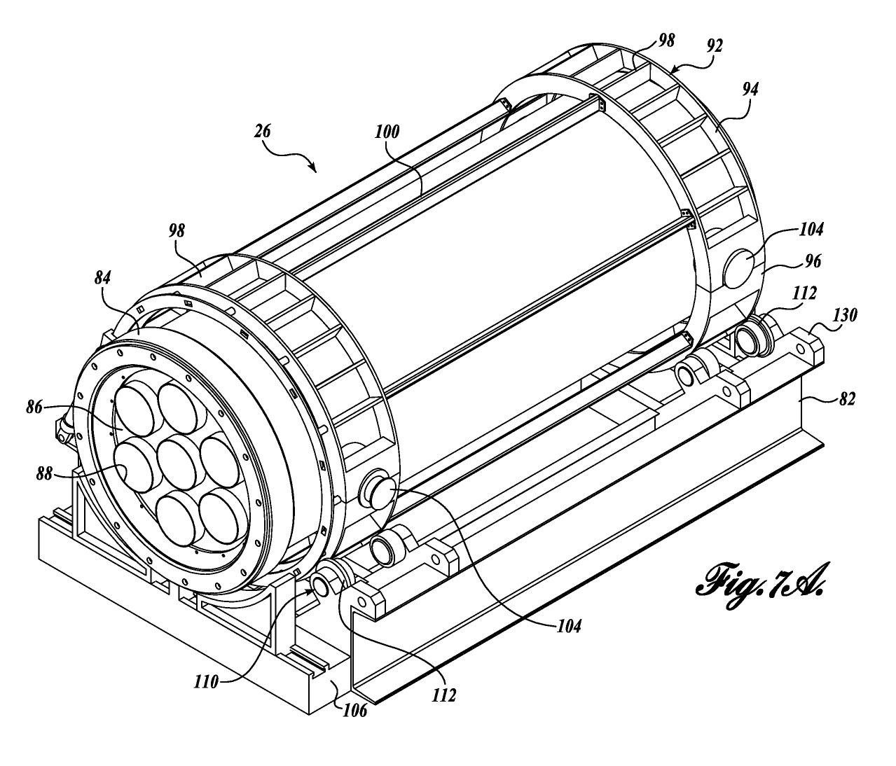

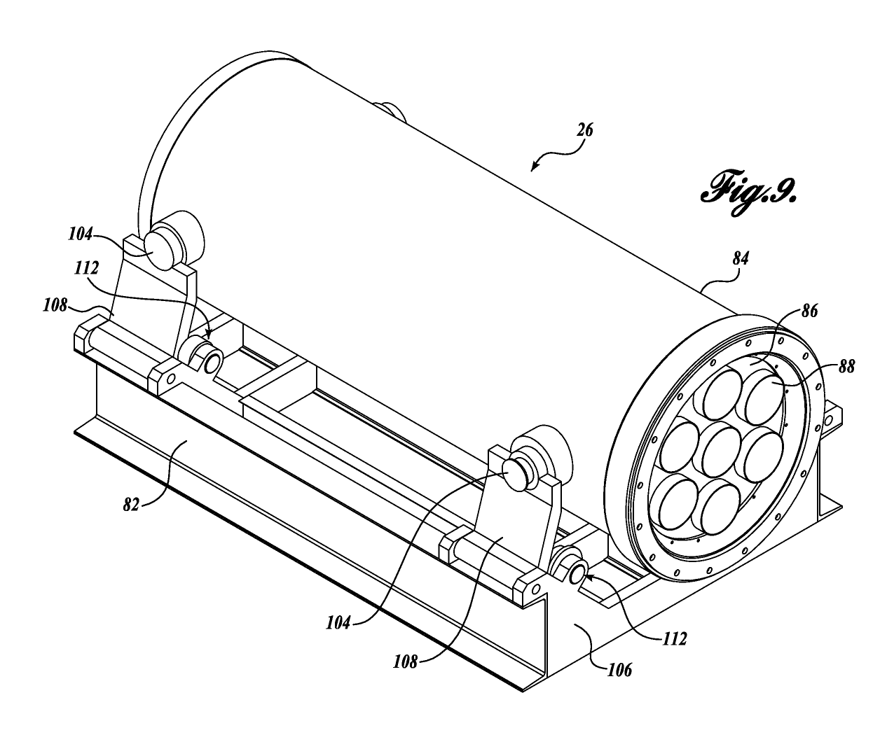

As described in greater detail below, indexing methods for aligning the transfer assembly 22, an aperture 38 in the shielding wall 24, and/or the container assembly 26 for ease of transfer of the material M to the container assembly 26 may include one or more of the following: (1) moving a shielding device 80 having an aperture 38 relative to the shielding wall 24 (see FIG. 6); (2) rotating the entire container assembly 26, for example, rotating the inner canister 86 (or basket) together with a rotating outer cask 84 (see FIGS. 7A-9); and (3) rotating a portion of the container assembly 26, for example, rotating an inner canister 286 (or basket) relative to a stationary outer cask 284 (see FIGS. 10-14).

The shielding wall 24 will now be described in greater detail. In accordance with one embodiment of the present disclosure, the shielding wall 24 may include an aperture 38 (for example, see FIG. 1). As mentioned above, the shielding wall 24 may further include a shielding device 80 positioned in or adjacent the shielding wall 24, the shielding device defining a body through which the aperture 38 extends. The shielding wall 24 and the optional shielding device 80 maintain shielding between the contaminated area C and non-contaminated areas outside of the shielding wall 24.

The shielding device 80 may be movable relative to the shielding wall 24 so that the aperture 38 is movable for indexing purposes. As can be seen in the illustrated embodiment of FIG. 6, the shielding device 80 can be configured to allow for indexing by using an indexing aperture 38 that is capable of rotating to align with the transfer assembly 22 and/or an open compartment 44 in the container assembly 26 when receiving material M (see, e.g., FIG. 5). However, it should be appreciated that the shielding device 80 may also be a stationary device. If stationary, the transfer assembly 22 would be configured to index to align with the fixed aperture 38 in the shielding device 80 or in the shielding wall 24 (for example, if the wall 24 does not include a shielding device 80).

Whether the system 20 has a stationary shielding device 80 or a stationary transfer assembly 22 or both, either the outer cask 84 or the inner canister 86 in the container assembly 26 may be configured to rotate to receive the material M in an open compartment 88. However, if both the shielding device 80 and transfer assembly 22 are configured to index with an open compartment 88 in the container assembly 26, then the container assembly 26 may remain stationary.

With reference to FIGS. 7A-9, a container assembly 26 designed in accordance with one embodiment of the present disclosure will now be described. The container assembly 26 includes an outer cask 84, an inner canister 86 (such as a dry-shielded canister “DSC”) having a plurality of compartments 88 for receiving material M (not shown, but see FIGS. 1 and 5), a support skid 82, and a track assembly 92. In the illustrated embodiment, the outer cask 84 is configured to be capable of rotation on the skid 82. As the outer cask 84 rotates, compartments 88 in the canister 86 can be indexed with, referring to FIGS. 1 and 5, the transfer assembly 22 and an aperture 38 in the shielding wall 24 to receive material M that is being transferred from the transfer assembly 22.

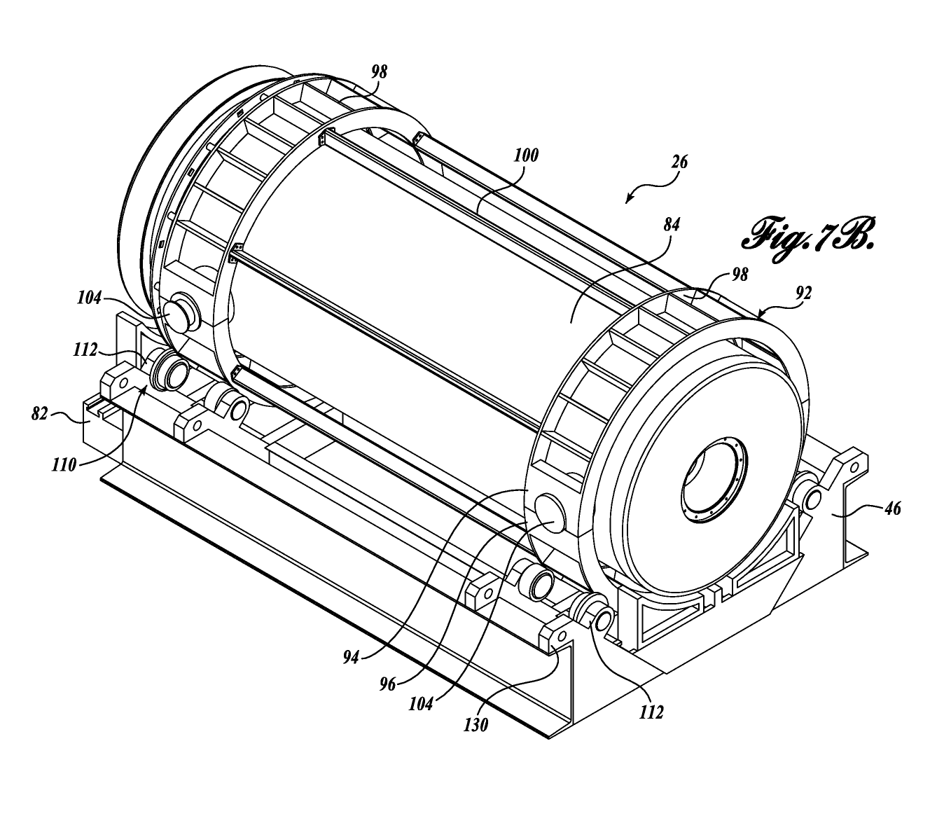

Referring to FIG. 8, the outer cask 84 and inner container 86 are both substantially cylindrical containers. The inner container 86 is configured to nest within the outer cask 84 and may include any number of compartments 88 for receiving material M. As non-limiting examples, the canister 94 may include five or seven compartments. It should be appreciated that the inner structure need not be an inner canister, but may also be a basket or other suitable structure having a plurality of compartments for receiving material M.

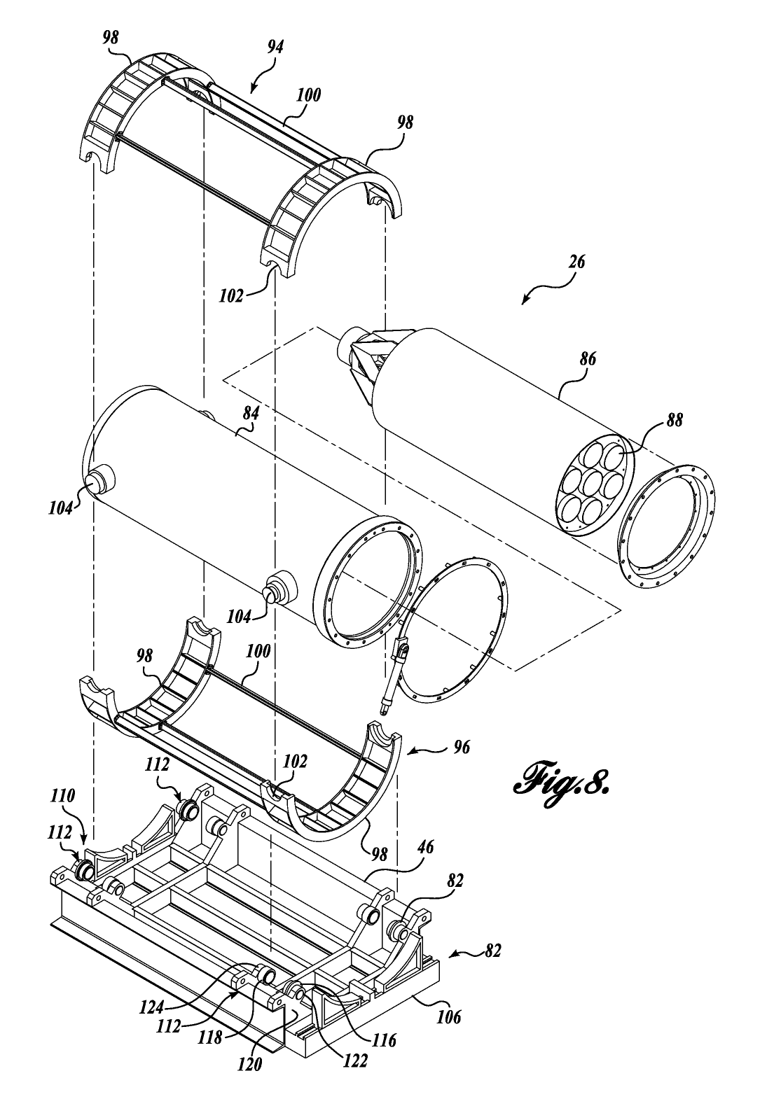

The outer cask 84 includes trunnions 104 extending from its exterior surface from which the outer cask 84 may be suspended to assist with adjusting and/or moving the outer cask 84. As seen in FIGS. 1, 7A, and 7B, a track assembly 92 may be configured to surround the exterior cylindrical surface of the outer cask 84. However, as can be seen in FIG. 9, the track assembly 92 is removable and may be disassembled and removed from the container assembly 26.

The removable track assembly 26 will now be described in greater detail. In the illustrated embodiment of FIGS. 7A and 7B (see also exploded view in FIG. 8), the track assembly 92 includes first and second track assembly portions 94 and 96. The track assembly 92 is designed and configured to surround the outer surface of the outer cask 84. In the illustrated embodiment, the first and second track assembly portions 94 and 96 include first and second tracks 98 connected by connector rods 100. The first and second track assembly portions 94 and 96 interface with one another at trunnion holes 102 defined in the track assembly portions 94 and 96 to surround trunnions 104 on the outer surface of the outer cask 84.

The track assembly 92 is designed to couple to the outer cask 84 to allow the outer cask 84 to rotate on the support skid 82, as will be described in greater detail below. The support skid 82 for the container assembly 26 includes a base 106 (for example, see FIGS. 7A and 7B), trunnion support assembly 108 (see FIG. 9), and a roller assembly 110 for interfacing with the track assembly 92 (see FIGS. 7A and 7B).

In the illustrated embodiment of FIGS. 7A and 7B (see also exploded view in FIG. 8), the roller assembly 110 includes a plurality of roller sets 112. Each roller set 112 includes a pair of opposed rollers 116 and 118 coupled to a roller holding device 120 having first and second arms 122 and 124 for holding respective first and second rollers 116 and 118. Spacing between the first and second rollers 116 and 118 allows for a trunnion 104 to pass therebetween. In the illustrated embodiment, the first roller 116 of each set has an outer flange to prevent the track assembly 92 from slipping off the roller assembly 110.

Referring to FIGS. 1 and 5, the track assembly 92 and the roller assembly 110 allow the outer cask 84 (which contains the inner canister 86) to rotate on the skid 82 to index an open compartment 88 in the canister 86 with the transfer assembly 22 when receiving material M. As can be seen in FIGS. 8 and 9, the track assembly 92 may be removable when it is desirable to maintain the container assembly 26 in a stationary configuration on the skid 82 (for example, during transport).

Referring to FIG. 9, a container assembly 26 and the skid 82 are shown in the fixed or stationary configuration. In that regard, the track assembly 92 has been removed, and a trunnion support assembly 108 is oriented in a supporting orientation for maintaining the cask 84 in a fixed configuration on the skid 82. Therefore, the trunnions 104 on the outer surface of the outer cask 84 rest on the plurality of trunnion supports 108.

As seen in FIGS. 7A and 7B, the trunnion support assembly 108 is configurable to be in a stowed orientation. Therefore, the trunnion support assembly 108 is configurable between a first stowed orientation for rotating the cask 84 on the skid 82 (see FIGS. 7A and 7B) and a second supporting orientation for maintaining the cask 84 in a fixed configuration on the skid 82 (see FIG. 9), for example, during transport. In the illustrated embodiment, the individual trunnion supports 108 are hinged supports capable of pivotable movement between the first orientation (see FIGS. 7A and 7B) and the second orientation (see FIG. 9).

The operation of the exemplary system 20 shown in FIGS. 1-9 will now be described in greater detail. Referring to FIG. 2, material M can be received by the material receiving assembly 32 of the transfer assembly 22 in a vertical orientation. However, it should be appreciated that the material need not be received in the vertical orientation, and, for example, may be received in a horizontal orientation (see, e.g., positioning of material receiving assembly 32 in FIG. 3).

Referring to FIG. 3, the material receiving assembly 32 is actuated to a horizontal position to align with the material delivery assembly 34 (see also FIG. 1). Referring to FIG. 4, the stop 46 is released from the second end 44 of the material receiving assembly 32 and the telescoping ramming device 60 is activated to enter the first end 42 of the material receiving assembly 32 and drive the material M from the second end 44 material receiving assembly 32 (see also FIG. 5).

Referring to FIG. 5, the material M may be driven from the material receiving assembly 32 of the transfer assembly 22 though an aperture 38 in the shielding wall 24 and/or into the container assembly 26. In that regard, the container assembly 26 includes an inner canister 86 having one or more compartments 88 for receiving material M. Therefore, the container assembly 26 must be suitably oriented to receive the material M in one of the compartments 88.

Methods of indexing are used to index or align the various components of the system 20, for example, the transfer assembly 22, the aperture 38 in the shielding wall 24, and the compartment 88 in the container assembly 26. For example, for material M that travels from the transfer assembly 22 through the aperture 38 in the shielding wall 24 into a compartment 88 in the container assembly 26, aligning is required between the transfer assembly 22 and the aperture 38 in the shielding wall 24 and between the aperture 38 and the container assembly 26. In accordance with methods described herein, exemplary solutions for indexing the system 20 are provided, as follows:

(1) The container assembly 26 (both the outer cask 84 and the inner canister 86) remain stationary or fixed, and the transfer assembly 22 and the aperture 38 in the shielding wall 24 index to align with individual compartments 88 in the canister 86.

(2) The container assembly 26 (both the outer cask 84 and the inner canister 86) remain stationary or fixed, and there is a single fixed aperture 38 in the shielding wall 24, which may be the size of the diameter of the canister 86 to accommodate the transfer of the material M to the plurality of individual compartments 88 in the canister 86. Therefore, only the transfer assembly 26 is required to index to align the delivery of the material M with each of the individual compartments 88 in the canister 86.

(3) The container assembly 26 rotates (for example, either the outer cask 84 in the present embodiment, or the inner canister 286, as described in alternate embodiment below) to align with a fixed aperture 38 and a fixed transfer assembly 22.

Although three exemplary situations have been explained, embodiments of the present disclosure may be directed to the different components of the system 20 and not the entire system 20. Therefore, it should be appreciated that there may be other indexing situations that are within the scope of the present disclosure besides the examples provided herein.

First, the indexing of the transfer assembly 22 will be described. Such indexing may be achieved by moving the transfer assembly 22 to align with the aperture 38 and the receiving compartment 88 in the container assembly 26. As described above with reference to FIG. 1, the indexing assembly 28 of the transfer assembly 22 includes both horizontal and vertical adjustment components. In that regard, vertical and horizontal adjustments can be made to align the material receiving assembly 32 of the transfer assembly 22 with other components in the system 20 (for example, the aperture 38 in the shielding wall 24) and enable directed delivery of the material M.

Second, in addition to indexing the transfer assembly 22 to align with the aperture 38 in the shielding wall 24, the aperture 38 may also be indexed to align with the material receiving assembly 32 of the transfer assembly 22 and/or the receiving compartment 88 in the container assembly 26. As described above with reference to FIG. 6, a shielding device 80 disposed near or in the shielding wall 24 can be configured to allow for indexing by moving (such as rotating) an indexing aperture 38 to align with the transfer assembly 22 and/or an open compartment 44 in the container assembly 26 when receiving material M (see, e.g., FIG. 5).

Without such a rotating shielding device 80 (or a movable container assembly 26), the shielding wall 24 would require a larger diameter aperture or a certain number of apertures to coordinate with the compartments 44 in the container assembly 26. A larger diameter aperture and multiple apertures are within the scope of the present disclosure, and would likely not significantly affect the containment of contamination in the contaminated area C. Contamination control is primarily achieved by embodiments of the present disclosure because of the reduction of the ingress and egress of vehicles in and out of the contaminated area C.

Third, the indexing of the container assembly 26 will now be described. In that regard, portions of the container assembly 26 may be movable or otherwise rotatable to index a compartment 88 with the aperture 38. In the illustrated embodiment of FIGS. 7A and 7B, the inner canister 86 is fixed within the outer cask 84, and the outer cask 84 is configured to move or rotate on the skid 82, thereby also rotating the inner canister 86 with the outer cask 84. As the outer cask 84 moves, an open compartment 88 in the inner canister 86 can be aligned with the aperture 38 in the shielding wall 24 to receive material M therethrough. After the container assembly 26 has been filled with material M, the cask can be configured on the skid in its non-rotating configuration (see FIG. 9). As described below with reference to FIGS. 10-14, the inner canister 286 may also be rotatable relative to a fixed outer cask 284.

Turning now to FIGS. 10-14, a container assembly 226 designed and configured in accordance with another aspect of the present disclosure is shown. It should be appreciated that the container assembly of FIGS. 10-14 is substantially similar to the container assembly 26 of FIGS. 1-9, except primarily for differences regarding the rotation of the compartments 288 in the container assembly 226. Like numerals for the embodiment shown in FIGS. 1-9 are used for the alternate embodiment shown in FIGS. 10-14, except in the 200 series.

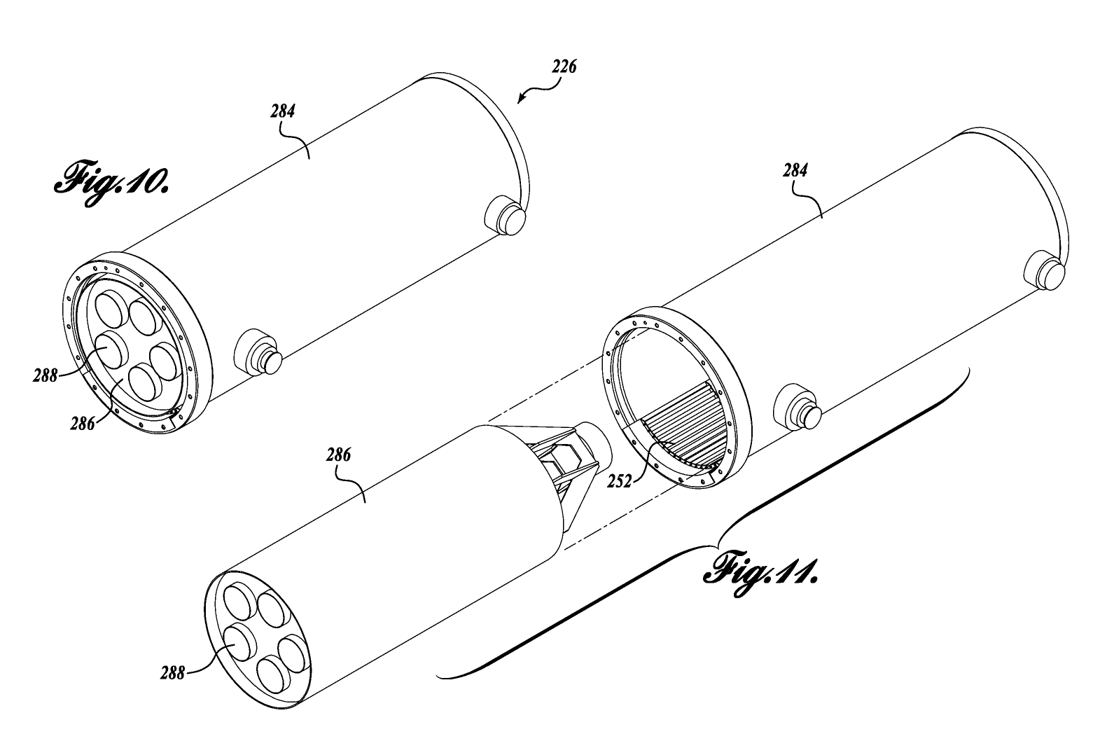

Referring to FIGS. 10 and 11, the container assembly 226 is designed and configured to enable rotation of the inner canister 286 relative to a non-rotating outer cask 284. As discussed above, when an aperture in the shielding wall is a stationary or fixed aperture, an open compartment 288 in the inner canister 286 must be moved to align with the aperture (not shown) to receive material M therethrough. In the illustrated embodiment of FIGS. 1-9, the outer cask 84 is configured to be rotatable on the skid 82. The inner canister 86, fixed within the outer cask 84, thereby moves with the outer cask 84. Therefore, an open compartment 88 can be indexed with the aperture 38 in the shielding wall 24.

In accordance with the present embodiment, the inner canister 286 is configured to rotate within the stationary outer cask 284. In that regard, the outer cask 284 may be configured to rest its trunnions 204 on trunnion supports (see, e.g., FIG. 9). To facilitate rotation of the inner canister 286 relative to the outer cask 284, the container assembly 226 may include a rotation assembly 252. For example, in the illustrated embodiment, the outer cask 284 includes a roller bearing assembly 254 extending along at least a portion of its inner wall. However, it should be appreciated that the roller bearing assembly 254 may extend along the entire inner wall of the outer cask 284 or could be disposed on at least a portion of the outer wall of the inner canister 286. More over, a roller bearing assembly or any type of bearing assembly is not necessary to enable rotation of the inner canister 286 relative to the outer cask 284.

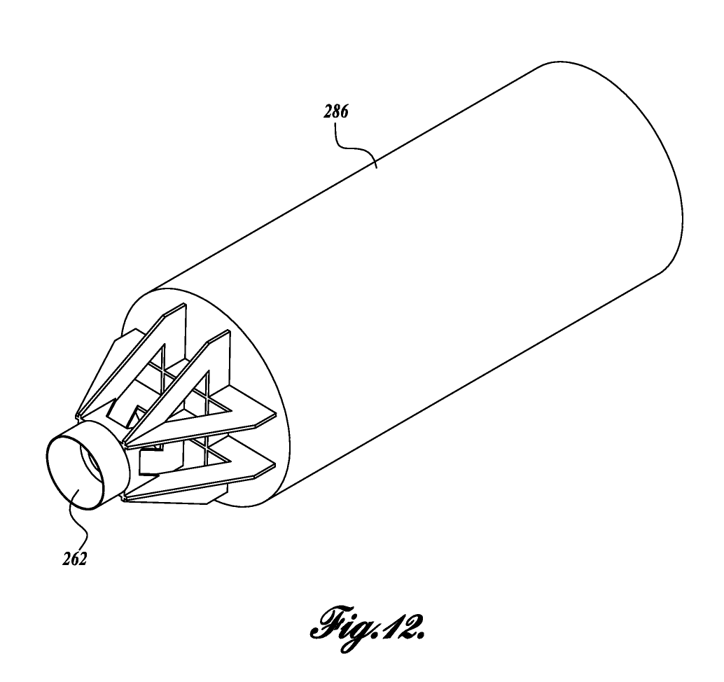

Referring to FIG. 12, the tail end 262 of the inner canister 286 is shown, which may assist in rotating the canister 42. As mentioned above, it should be appreciated that the inner structure need not be an inner canister, but may also be a basket or other suitable structure having a plurality of compartments for receiving material.

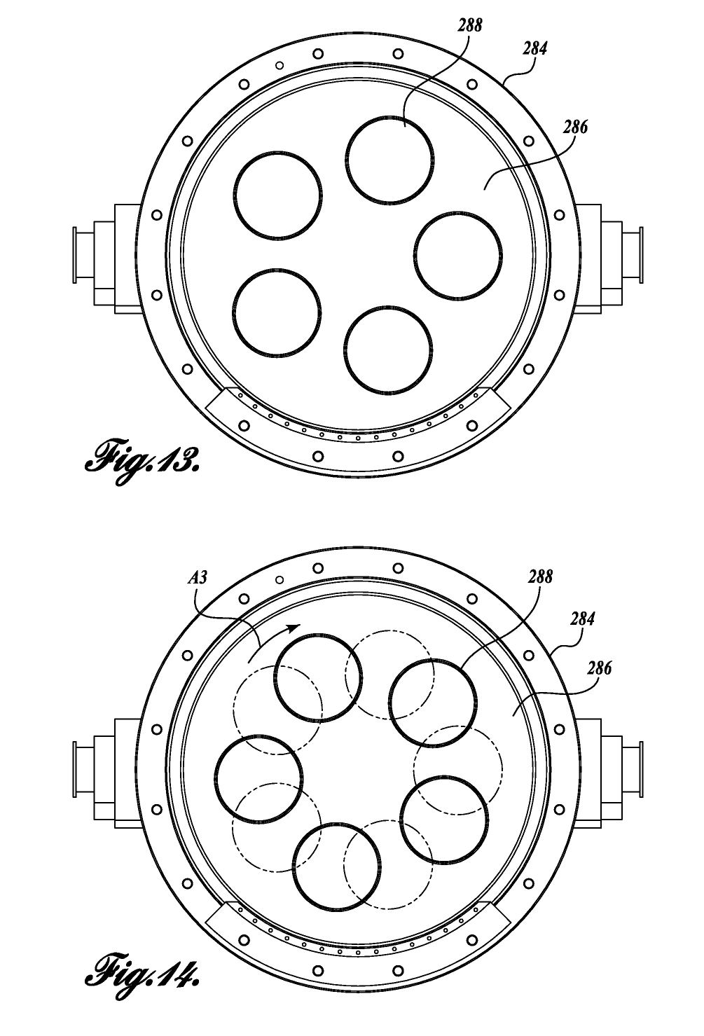

Referring to FIGS. 13 and 14, the rotational movement of the canister 42 relative to a stationary cask 40 in accordance with this embodiment is shown as arrow A3. However, it should be appreciated that rotation may be in either clockwise or counterclockwise directions. As a result of the rotational movement of the inner canister 42 relative to the outer cask 40, an open compartment 44 in the inner canister can be indexed with either or both of the aperture in the shielding wall and with the material receiving assembly of the transfer assembly when receiving material M.

While illustrative embodiments have been illustrated and described, it will be appreciated that various changes can be made therein without departing from the spirit and scope of the disclosure.

1. A method of transferring radioactive material from a contaminated area to a container assembly, the method comprising:
(a) acquiring radioactive material in a contaminated area, wherein the contaminated area includes at least one shielding wall; and
(b) moving the material in the substantially horizontal orientation through an aperture in a shielding wail into a container assembly.

2. The method of claim 1, wherein the material is acquired in a substantially vertical orientation, further comprising transferring the material from the substantially vertical orientation to a substantially horizontal orientation before moving the material.

3. The method of claim 1, wherein the container assembly includes a structure with a plurality of compartments for receiving radioactive material.

4. The method of claim 1, wherein the container assembly includes a canister for receiving radioactive material.

5. The method of claim 1, wherein transferring the material from the substantially vertical orientation to the substantially horizontal orientation includes loading the material in a transfer assembly.

6. The method of claim 5, wherein the transfer assembly includes a material delivery assembly for moving the material from the transfer assembly in the substantially horizontal orientation through the aperture in the shielding wall into the container assembly.

7. The method of claim 6, wherein the shielding wall comprises a shielding device.

8. The method of claim 7, wherein the aperture is disposed in the shielding device, and wherein the shielding device rotates to align the aperture with one or more of a plurality of compartments in the container assembly.

9. The method of claim 1, further comprising indexing the transfer assembly with the aperture in a shielding wall by moving at least one of the transfer assembly and the aperture.

10. The method of claim 5, further comprising indexing the transfer assembly with an open compartment in the container assembly by moving at least one of the transfer assembly, the aperture, and the container assembly.

11. A transfer assembly for radioactive material, the transfer assembly comprising:
(a) a material receiving assembly having an outer wall defining an inner bore and first and second open ends, wherein the material receiving assembly receives radioactive material when it is in a first orientation, and wherein the material receiving assembly rotates to a second orientation;
(b) a material delivery assembly configured for translational movement between the first and second ends of the material receiving assembly.

12. The transfer assembly of claim 11, wherein the first orientation is a substantially vertical orientation.

13. The transfer assembly of claim 11, wherein the second orientation is a substantially horizontal orientation.

14. The transfer assembly of claim 11, wherein the transfer assembly further includes a material retaining device located at the second open end.

15. The transfer assembly of claim 11, wherein the material is loaded into the material receiving assembly by vertically loading the material at the first open end.

16. The transfer assembly of claim 11, wherein the outer wall of the material receiving assembly has a half-trough cross-section defining an open side and one or more clamping devices.

17. The method of claim 16, wherein the material is loaded into the material receiving assembly by horizontally loading the material into the open side.

18. The method of claim 11, wherein the transfer assembly further includes a rotating device for rotating the material from the substantially vertical orientation to the substantially horizontal orientation.

19. The method of claim 11, wherein the transfer assembly further includes an indexing assembly for adjusting the coordinates of the material delivery assembly.

20-25. (canceled)

26. A system for transferring radioactive material from a contaminated area to a container assembly, the system comprising:
(a) at least one shielding wall having an aperture therethrough;
(b) a transfer assembly for delivering material through the aperture; and
(c) a container assembly for receiving the material.
